(19) United States
(12) Patent Application Publication
(10) Pub. No.: US 2012/0162386 A1
(43) Pub. Date: Jun. 28, 2012

(54) APPARATUS AND METHOD FOR CORRECTING ERROR IN STEREOSCOPIC IMAGE

(75) Inventors: Hye-Sun KIM, Daejeon (KR); Yun-Ji BAN, Daejeon (KR)

(73) Assignee: Electronics and Telecommunications Research Institute, Daejeon (KR)

(21) Appl. No.: 13/335,612

(22) Filed: Dec. 22, 2011

(30) Foreign Application Priority Data
Dec. 22, 2010 (KR) 10-2010-0132867
Mar. 17, 2011 (KR) 10-2011-0024032

(51) Int. Cl. H04N 13/02; G06K 9/00

(52) U.S. Cl. 348/47; 382/154; 348/E13.074; 348/E13.014; 348/E13.016

(57) ABSTRACT

Disclosed herein are an apparatus and method for correcting an error in a stereoscopic image. The apparatus includes two cameras, a region extraction unit, a phase difference calculation unit, an error value extraction unit, and an error analysis unit. The cameras capture left and right images forming the stereoscopic image. The region extraction unit extracts the main regions of interest from each of the images. The phase difference calculation unit calculates the difference in phase between the main regions of interest of the left image and the main regions of interest of the right image. The error value extraction unit extracts the value of a camera disposition error, corresponding to locations of the two cameras, based on the difference in phase. The error analysis unit determines whether the value of the camera disposition error is within a set range, and corrects the error in the stereoscopic image.

### CROSS REFERENCE TO RELATED APPLICATIONS

This application claims the benefit of Korean Patent Application Nos. 10-2010-0132867 and 10-2011-0024032, filed on Dec. 22, 2010 and Mar. 17, 2011, respectively, which are hereby incorporated by reference in their entirety into this application.

### BACKGROUND OF THE INVENTION

1. Technical Field

The present invention relates generally to an apparatus and method for correcting an error in a stereoscopic image and, more particularly, to an apparatus and method for correcting an error that is generated when a stereoscopic image is captured.

2. Description of the Related Art

A human can perceive the depth of an object when viewing the object because different images are transferred to his or her brain via his left and right eyes at different locations. That is, the brain of a human recognizes the depth of an object by using a difference in phase between two images received via left and right eyes.

In order to capture a stereoscopic moving image, there is a need for two left and right cameras corresponding to the left and right eyes of a human. In order to produce a desired sensation of depth by using the two cameras, a device called a rig is necessary. The rig functions as a stand on which the two cameras can be placed, and also functions to set the locations and directions of the cameras similarly to the eyes of a human.

A conventional stereoscopic moving image capturing apparatus including two cameras and a rig may represent the sensation of depth of an image depending on the locations of the two cameras and the directions in which the cameras perform capturing.

If the two cameras are erroneously disposed, a user may feel dizzy. For example, if the coordinate axes of the two cameras are oriented in different directions or the coordinate axes are distorted, a user may feel dizzy during the process of perceiving the depth of an image.

In the process of perceiving the depth of the image, the erroneous disposition of the cameras must be corrected. A method of correcting the locations of the cameras includes a method in which a movie director directly corrects left and right images, captured by the cameras, using his or her eyes, and a method of correcting the left and the right images by using an image processor.

For example, if a High-Definition (HD) or higher level moving image is analyzed by using image processors, a problem arises in that frames are delayed or lost due to the processing time that is taken when each of the image processors is applied to each of the pixels of the moving image.

An HD level stereoscopic moving image includes 1280 pixels in length×1024 pixels in width=about 1.3M pixels per frame. Furthermore, an HD level stereoscopic moving image can be processed in real time only when 25 or more frames of left and right images (i.e., images obtained by two cameras) are processed per second. That is, in order to analyze a difference in phase between the two left and right images, 65M pixels must be analyzed per second.

The method of analyzing the two left and right images, however, is problematic in that real-time processing is difficult due to a complicated algorithm, and frames are delayed or lost.

### SUMMARY OF THE INVENTION

Accordingly, the present invention has been made keeping in mind the above problems occurring in the prior art, and an object of the present invention is to provide an apparatus and method for correcting errors that are generated when a stereoscopic image is captured in real time.

In order to accomplish the above object, the present invention provides an apparatus for correcting an error in a stereoscopic image, the apparatus including two cameras for capturing left and right images, respectively, the left and right images forming the stereoscopic image; a region extraction unit for extracting main regions of interest from each of the left and right images; a phase difference calculation unit for calculating a difference in phase between the main regions of interest of the left image and the main regions of interest of the right image; an error value extraction unit for extracting a value of a camera disposition error, corresponding to locations of the two cameras, based on the difference in phase between the main regions of interest; and an error analysis unit for determining whether the value of the camera disposition error is within a set range, and correcting the error in the stereoscopic image based on results of the determination.

The region extraction unit may segment each of the left and right images into a plurality of regions, and extract a focusing region and corner regions, from among the segmented regions, as the main regions of interest

The focusing region may be a center region of each of the left and right images, and include a point on which the camera is focused.

The corner regions may be regions corresponding to corner portions of the left and right images.

The phase difference calculation unit may generate a phase difference analysis diagram by displaying motion vectors, corresponding to the difference in phase, in the main regions of interest.

The motion vectors may be moved so that the main regions of interest of the left image are matched with the main regions of interest of the right image.

The value of the camera disposition error may correspond to the value of the difference between the locations of the two cameras and reference camera locations where the stereoscopic image is captured.

The error analysis unit may cause the disposition of the two cameras to be corrected manually or automatically when the value of the camera disposition error exceeds the set range.

The error analysis unit may correct the left image and/or the right image by using image processing when the value of the camera disposition error exceeds the set range.

In order to accomplish the above object, the present invention provides a method of correcting an error in a stereoscopic image acquired by using two cameras, the method including obtaining left and right images, the left and right images forming the stereoscopic image; extracting main regions of interest from each of the left and right images; calculating a difference in phase between main regions of interest of the left image and main regions of interest of the right image; extracting a value of a camera disposition error, corresponding to locations of the two cameras, based on the difference in phase between the main regions of interest; and making a determination of whether the value of the camera disposition error is within a set range and correcting the error in the stereoscopic image based on a result of the determination.

The extracting main regions of interest may include segmenting each of the left and right images into a plurality of regions; and extracting a focusing region and corner regions, from among the segmented regions, as the main regions of interest

The focusing region may be a center region of each of the left and right images, and include a point on which the camera is focused.

The corner regions may be regions, corresponding to corner portions of the left and right images.

The calculating a difference in phase may include generating a phase difference analysis diagram by displaying motion vectors, corresponding to the difference in phase, in the main regions of interest.

The motion vectors may be moved so that the main regions of interest of the left image are matched with the main regions of interest of the right image.

The value of the camera disposition error may correspond to the value of the difference between the locations of the two cameras and reference camera locations where the stereoscopic image is captured.

The correcting the error in the stereoscopic image may include causing the error in the stereoscopic image by correcting the disposition of the two cameras to be corrected manually or automatically when the value of the camera disposition error exceeds the set range.

The correcting the error in the stereoscopic image comprises correcting the error in the stereoscopic image by using image processing when the value of the camera disposition error exceeds the set range.

### BRIEF DESCRIPTION OF THE DRAWINGS

The above and other objects, features and advantages of the present invention will be more clearly understood from the following detailed description taken in conjunction with the accompanying drawings, in which:

FIG. 1 schematically shows the configuration of an apparatus for correcting an error in a stereoscopic image according to an embodiment of the present invention;

FIG. 2 is a diagram showing left and right images applied to the apparatus for correcting an error in a stereoscopic image according to an embodiment of the present invention;

FIG. 3 is a diagram showing the main regions of interest in left and right images applied to the apparatus for correcting an error in a stereoscopic image according to the embodiment of the present invention;

FIG. 4 is a diagram showing left and right images corresponding to the subjects of capturing according to an embodiment of the present invention;

FIG. 5 is a diagram showing the difference in phase when two cameras for capturing a stereoscopic image are suitably disposed according to an embodiment of the present invention;

FIGS. 6 to 8 is a diagram showing a difference in phase when two cameras for capturing a stereoscopic image are erroneously disposed according to an embodiment of the present invention;

FIG. 9 is a flowchart illustrating a stereoscopic capturing method to which a method of correcting an error in a stereoscopic image according to an embodiment of the present invention is applied; and

FIG. 10 is a flowchart illustrating a method of correcting an error in a stereoscopic image according to an embodiment of the present invention.

### DESCRIPTION OF THE PREFERRED EMBODIMENTS

Reference now should be made to the drawings, throughout which the same reference numerals are used to designate the same or similar components.

An apparatus and method for correcting an error in a stereoscopic image according to embodiments of the present invention are described in detail below with reference to the accompanying drawings.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

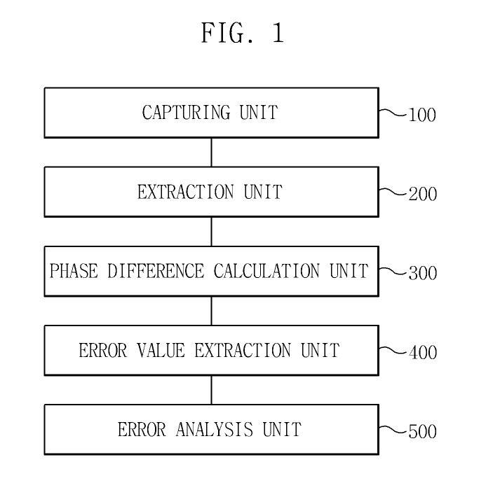

FIG. 1 schematically shows the configuration of an apparatus for correcting an error in a stereoscopic image according to an embodiment of the present invention.

Referring to FIG. 1, the apparatus for correcting an error in a stereoscopic image includes a capturing unit 100, a region extraction unit 200, a phase difference calculation unit 300, an error value extraction unit 400, and an error analysis unit 500.

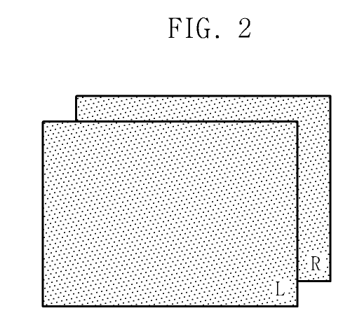

The capturing unit 100 includes cameras for capturing a stereoscopic image (i.e., two cameras for capturing the left and right sides of the same subject). The two cameras correspond to devices for capturing an HD or higher level stereoscopic moving image. As shown in FIG. 2, the capturing unit 100 captures the left and right images L and R of a subject by using the two cameras.

According to an embodiment of the present invention, the two cameras of the capturing unit 100 have a structure similar to that of the eyes of a human, and capture the left and right images L and R of the subject, but the present invention is not limited thereto.

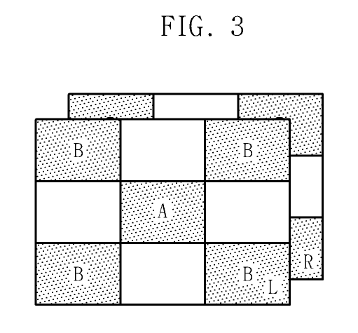

The region extraction unit 200 extracts the main regions of interest from the left and right images. The main regions of interest may be extracted from the left and right images, as shown in FIG. 3, but the present invention is not limited thereto. Furthermore, the region extraction unit 200 shades and displays the extracted major regions of interest.

As shown in FIG. 3, the region extraction unit 200 segments each of the left and right images into a plurality of regions, and extracts a focusing region A and corner regions B, from among the segmented regions, as the main regions of interest. The focusing region A is the center region of each of the left and right images, and is the region that has the highest degree of interest. Furthermore, the focusing region A includes a point at which the two cameras are focused, and has the smallest difference in phase between the left and right images. The corner region B corresponds to a corner portion in both the left and right images, and may have the greatest difference in phase between the two cameras due to the error in the disposition of the cameras.

The phase difference calculation unit 300 calculates the difference in phase between the main regions of interest of the left image and the main regions of interest of the right image, and generates the phase difference analysis diagram based on results of the calculation.

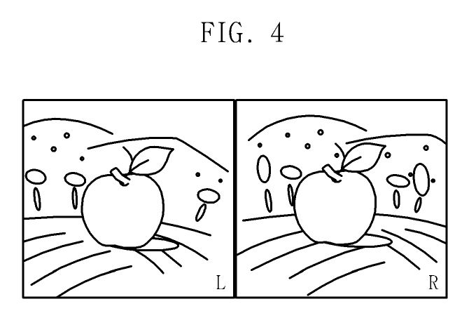

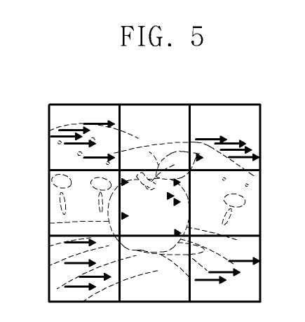

For example, the phase difference calculation unit 300 may calculate the difference in phase between the left and right images L and R, such as that shown in FIG. 4. The phase difference calculation unit 300 generates a phase difference analysis diagram, such as that shown in FIG. 5, based on the difference in phase.

FIG. 5 shows the phase difference analysis diagram which corresponds to locations most suitable for the two cameras to capture the subject, that is, reference camera locations.

Referring to FIG. 5, the arrows included in the phase difference analysis diagram correspond to motion vectors that are used to match the feature points of the left image with the feature points of the right image.

The phase difference calculation unit 300 calculates a difference only in the phase in the main regions of interest A and B of the left and right images, and displays motion vectors (i.e., arrows) in the main regions of interest based on the calculated difference in phase. Here, the arrows indicate the verticality, horizontality, rotation, and the enlarged movement of the two cameras which are produced in order to indicate a sensation of depth of the image.

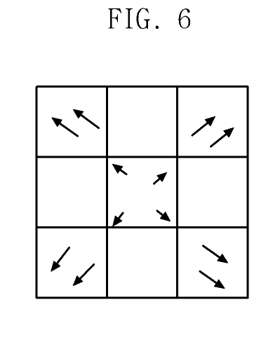

The difference in phase that occurs when the two cameras for capturing a stereoscopic image are erroneously disposed will now be described in detail with reference to FIGS. 6 to 8.

FIG. 6 shows the phase difference analysis diagram which indicates the difference in phase between the main regions of interest of the left image and the main regions of interest of the right image when an image captured by the right camera is more enlarged than an image captured by the left camera according to an embodiment of the present invention.

Referring to FIG. 6, arrows oriented towards the outside in the phase difference analysis diagram correspond to motion vectors that are used to match the feature points of the left image with the feature points of the enlarged right image. That is, the phase difference calculation unit 300 may determine that an image captured by the right camera is more enlarged than an image captured by the left camera based on the difference in phase.

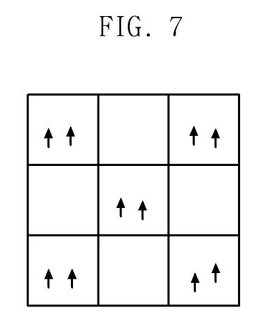

FIG. 7 shows the phase difference analysis diagram which indicates the difference in phase between the main regions of interest of the left image and the main regions of interest of the right image when the right camera is placed higher than the left camera according to an embodiment of the present invention.

Referring to FIG. 7, arrows oriented toward the upper side in the phase difference analysis diagram correspond to motion vectors that are used to match the feature points of the left image with the feature points of the right image which is placed on the upper side of the right image. That is, the phase difference calculation unit 300 may determine that the right camera is placed on the upper side of the left camera based on the difference in phase.

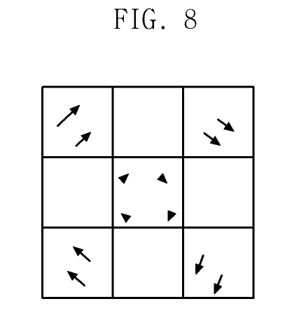

FIG. 8 shows the phase difference analysis diagram which shows the difference in phase between the main regions of interest of the left image and the main regions of interest of the right image when the right camera has been rotated relative to the Z axis according to an embodiment of the present invention.

The phase difference calculation unit 300 may quickly find an error in the disposition of the cameras by calculating not all the regions of the left and right images but the difference in phase between the main regions of interest. Furthermore, the phase difference calculation unit 300 may guarantee a real-time feature by reducing the subject for which the difference in phase must be calculated to 5/9.

The error value extraction unit 400 extracts the value of a camera disposition error, for the locations of the left and right cameras, based on the calculated difference in phase between the main regions of interest. The value of the camera disposition error corresponds to the value of the difference between the locations of the left and right cameras and the reference camera locations, which correspond to locations that are the most suitable to capturing the subject.

If the value of the camera disposition error exceeds a set range, the error analysis unit 500 causes the locations of the left and right cameras to be corrected manually or automatically. The error analysis unit 500 may indirectly correct an error in the left and right images by using image processing, in addition to the method of directly correcting an error in the locations of the cameras as described above. In this case, the error analysis unit 500 includes an image processor for performing the image processing. For example, the error analysis unit 500 may acquire left and right images whose error has been corrected by applying the value of the error to the image processor.

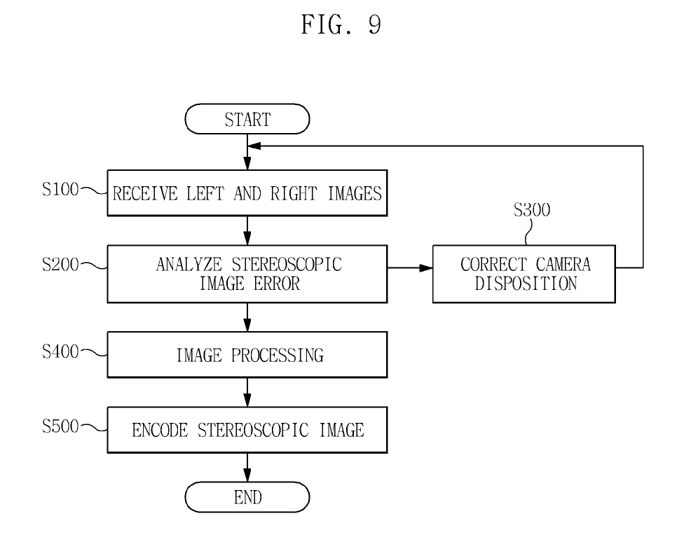

A stereoscopic capturing method by using the method of correcting an error in a stereoscopic image will now be described in detail with reference to FIG. 9.

FIG. 9 is a flowchart illustrating the stereoscopic capturing method to which the method of correcting an error in a stereoscopic image according to an embodiment of the present invention is applied.

First, a capturing system (not shown) for capturing a stereoscopic image according to an embodiment of the present invention includes two cameras for capturing the left side and the right side of a subject.

Referring to FIG. 9, the capturing system acquires the left and right images L and R of the subject by using the two cameras at step S100. The two cameras capture the left and right images at points which are spaced apart by a specific interval, just as the left and right eyes of a human do.

The capturing system analyzes the value of a camera disposition error based on the captured left and right images at step S200. The value of the camera disposition error corresponds to the value of the difference between the locations of the left and right cameras and reference camera locations corresponding to the locations that are most suitable to capturing the subject. If, as a result of the analysis, the value of the camera disposition error exceeds a set range, the capturing system corrects the error in the locations of the left and right cameras at step S300.

Thereafter, the capturing system acquires left and right images whose error has been corrected through image processing at step S400.

The capturing system encodes a stereoscopic image corresponding to the corrected left and right images at step S500. However, if, as a result of the analysis, the value of the camera disposition error of the left and right images falls within the set range, the capturing system encodes a stereoscopic image corresponding to the left and right images.

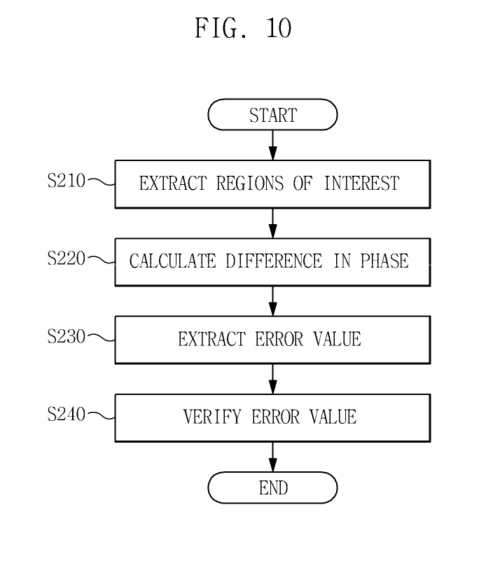

A method of correcting the value of a camera disposition error (i.e., an error in a stereoscopic image) generated during the process of capturing the stereoscopic image will now be described in detail with reference to FIG. 10.

FIG. 10 is a flowchart illustrating a method of correcting an error in a stereoscopic image according to an embodiment of the present invention.

First, the apparatus for correcting an error in a stereoscopic image according to the embodiment of the present invention may operate in conjunction with the capturing system for capturing the stereoscopic image, but is not limited thereto. Furthermore, the apparatus for correcting an error in a stereoscopic image obtains left and right images of the subject by using two cameras.

Referring to FIG. 10, the apparatus for correcting an error in a stereoscopic image extracts main regions of interest from the left and right images at step S210. More particularly, the error correction apparatus segments each of the left and right images into a plurality of regions, and extracts a focusing region A and corner regions B, from among the segmented regions, as the main regions of interest. The main regions of interest include the focusing region A and the corner regions B.

The error correction apparatus calculates the difference in phase between the main regions of interest of the left image and the main regions of interest of the right image at step S220. Furthermore, the error correction apparatus generates a phase difference analysis diagram by displaying motion vectors, corresponding to results of the calculation (i.e., the difference in phase), in the main regions of interest. The phase difference analysis diagram is as shown in FIGS. 5 to 8. The motion vectors are arrows indicative of the horizontal movements of the two cameras which occur to indicate the sensation of depth of the image.

The error correction apparatus extracts the value of a camera disposition error in the locations of the left and right cameras based on the difference in phase between the main regions of interest at step S230. The value of the camera disposition error corresponds to the value of the difference between the locations of the left and right cameras and reference camera locations that are the locations most suitable to capturing the subject.

The error correction apparatus determines whether the value of the camera disposition error falls within a set range, and verifies whether the value of the camera disposition error is safe based on the results of the determination at step S240.

More particularly, if the value of the camera disposition error falls within the set range, the error correction apparatus determines that the value of the camera disposition error is within a safe range.

However, if it is determined that the value of the camera disposition error does not fall within the set range, the error correction apparatus determines that the disposition of the left and right cameras corresponding to the value of the camera disposition error is erroneous. Furthermore, the error correction apparatus causes an error in the disposition of the left and right cameras to be corrected manually or automatically based on the value of the camera disposition error.

As described above, in accordance with the method of correcting an error in a stereoscopic image according to the embodiment of the present invention, a real-time feature can be guaranteed because the value of a camera disposition error can be calculated by not calculating the difference in phase between all the regions of the left and right images and the subject for which a difference in phase must be calculated is reduced to 5/9.

Furthermore, according to the embodiments of the present invention, the apparatus and method for correcting an error in a stereoscopic image can reduce the time taken for analysis by limiting the capacity of pixel data, generated in a process of processing a stereoscopic moving image in real time, to main regions of interest for analyzing an error.

Furthermore, the main regions of interest are limited to important points where errors are chiefly generated or which are being focused on. Accordingly, validity can be checked in a manner similar to that used by a movie director when he makes reference to a region by directly looking for errors with his eyes and manually finds the error.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for correcting an error in a stereoscopic image, the apparatus comprising:
two cameras for capturing left and right images, respectively, the left and right images forming the stereoscopic image;
a region extraction unit for extracting main regions of interest from each of the left and right images;
a phase difference calculation unit for calculating a difference in phase between the main regions of interest of the left image and the main regions of interest of the right image;
an error value extraction unit for extracting a value of a camera disposition error, corresponding to locations of the two cameras, based on the difference in phase between the main regions of interest; and
an error analysis unit for determining whether the value of the camera disposition error is within a set range, and correcting the error in the stereoscopic image based on results of the determination.

2. The apparatus as set forth in claim 1, wherein the region extraction unit segments each of the left and right images into a plurality of regions, and extracts a focusing region and corner regions, from among the segmented regions, as the main regions of interest

3. The apparatus as set forth in claim 2, wherein the focusing region is a center region of each of the left and right images, and includes a point on which the camera is focused.

4. The apparatus as set forth in claim 2, wherein the corner regions are regions corresponding to corner portions of the left and right images.

5. The apparatus as set forth in claim 1, wherein the phase difference calculation unit generates a phase difference analysis diagram by displaying motion vectors, corresponding to the difference in phase, in the main regions of interest

6. The apparatus as set forth in claim 5, wherein the motion vectors are moved so that the main regions of interest of the left image are matched with the main regions of interest of the right image.

7. The apparatus as set forth in claim 1, wherein the value of the camera disposition error corresponds to a value of a difference between the locations of the two cameras and reference camera locations where the stereoscopic image is captured.

8. The apparatus as set forth in claim 1, wherein the error analysis unit causes the disposition of the two cameras to be corrected manually or automatically when the value of the camera disposition error exceeds the set range.

9. The apparatus as set forth in claim 1, wherein the error analysis unit corrects the left image and/or the right image by using image processing when the value of the camera disposition error exceeds the set range.

10. A method of correcting an error in a stereoscopic image acquired by using two cameras, the method comprising:
obtaining left and right images, the left and right images forming the stereoscopic image;
extracting main regions of interest from each of the left and right images;
calculating a difference in phase between main regions of interest of the left image and main regions of interest of the right image;
extracting a value of a camera disposition error, corresponding to locations of the two cameras, based on the difference in phase between the main regions of interest; and
making a determination of whether the value of the camera disposition error is within a set range and correcting the error in the stereoscopic image based on a result of the determination.

11. The method as set forth in claim 10, wherein the extracting main regions of interest comprises:
segmenting each of the left and right images into a plurality of regions; and
extracting a focusing region and corner regions, from among the segmented regions, as the main regions of interest.

12. The method as set forth in claim 11, wherein the focusing region is a center region of each of the left and right images, and includes a point on which the camera is focused.

13. The method as set forth in claim 11, wherein the corner regions are regions, corresponding to corner portions of the left and right images.

14. The method as set forth in claim 10, wherein the calculating a difference in phase comprises generating a phase difference analysis diagram by displaying motion vectors, corresponding to the difference in phase, in the main regions of interest.

15. The method as set forth in claim 14, wherein the motion vectors are moved so that the main regions of interest of the left image are matched with the main regions of interest of the right image.

16. The method as set forth in claim 10, wherein the value of the camera disposition error corresponds to a value of a difference between the locations of the two cameras and reference camera locations where the stereoscopic image is captured.

17. The method as set forth in claim 10, wherein the correcting the error in the stereoscopic image comprises causing the error in the stereoscopic image by correcting the disposition of the two cameras to be corrected manually or automatically when the value of the camera disposition error exceeds the set range.

18. The method as set forth in claim 10, wherein the correcting the error in the stereoscopic image comprises correcting the error in the stereoscopic image by using image processing when the value of the camera disposition error exceeds the set range.
